(19) United States
(12) Patent Application Publication
(10) Pub. No.: US 2016/0059404 A1
(43) Pub. Date: Mar. 3, 2016

(54) Knife handle adaptor

(71) Applicant: James A. Stepp, Abingdon, VA (US)

(72) Inventor: James A. Stepp, Abingdon, VA (US)

(21) Appl. No.: 14/836,781

(22) Filed: Aug. 26, 2015

Related U.S. Application Data
(60) Provisional application No. 62/122,449, filed on Oct. 21, 2014.
(60) Provisional application No. 62/070,600, filed on Aug. 29, 2014.

(51) Int. Cl. B25G 3/30; B26B 3/00

(52) U.S. Cl. CPC B25G 3/30; B26B 3/00

(57) ABSTRACT

The present invention discloses adaptors to be used as a removable mounting platform for knife handles. These adaptors also connect to a rigid support tube adding stability to the adaptors. The connecting together of these components to the knife handle, provide a durable, sturdy, and removable platform for mounting knife handles, enables the capability of switching knife handles, and provides extended proximity of range when utilizing a knife.

### FIELD OF INVENTION

The present invention relates to adaptors. More particularly, relating to adaptors with a removable connection to a knife handle.

### BACKGROUND

In reference to application Ser. Nos. 62/122,499, and 62/070,600, I am applying for this non-provisional patent. These are two separate adaptors that when attached to a hiking, defense, or other such staff on one end, and a knife handle on the other end, will provide a durable, sturdy, removable mounting platform. A durable platform for mounting a commercially available fixed blade knife on a staff is not available.

Prior to these adaptors, a durable platform for mounting a commercially available fixed blade knife on a staff was not available. People in the martial arts, hiking, and hunting community expressed a need for a strong platform in order to mount knife blades to extend their range of proximity when a situation called for it. After reading many comments on Amazon, E-bay, chat rooms, and social media about the lack of a good system to attach a knife to a staff or support mechanism, there was no doubt an adaptor was needed; an adaptor that would be durable, and simple to use.

Prior art shows staffs with their unique knives or knife blades for their particular staff. Specialty knife, staff, and survival companies offer their own knife/attachment system, and staff options. The need for a durable platform for mounting an already purchased knife remains. The need for a platform that is interchangeable and universal enough to host numerous blades remains. Research shows that Sog, Smith & Wesson, and Cold Steel are popular knives for hunting and survival. Providing a platform for knives such as the Sog Spirits, Smith & Wesson SW8, Cold Steel Bushman, and others sold outside of a kit, can eliminate unnecessary purchases allowing the consumer to save money.

These adaptors are each made into a single apparatus for simplistic attaching and efficient use of time. There is no special knowledge needed to utilize these adaptors. One end of the adaptor connects to an a staff, rod, pole, or like handle and the other end attaches to a multitude of knife handles while providing strength, durability, stability, and convertibility. The knife is easily converted from knife to longer knife to knife again. This is a simple procedure entailing the screwing together of components. This type of connection is secure while remaining removable, accomplished by taking a steel bar and threading it at both ends. One end is threaded to fit into a knife handle while the other end is threaded to fit into a tube. A preferred embodiment of this tube is substantial gage aluminum with interior threading. This allows the adaptor to be light-weight, and remain sturdy. It is not flimsy or unsteady. The interior threads are complementary to one end of the adaptor. The adaptors also have to be of substantial material in order for the whole platform to remain sturdy and steady. The knife industry has manufactured many knife handles threaded to fit directly onto an extended handle such as mop, broom, or rake handles, as well as others. With the adaptor, the knife handle has a secure and solid connection to a handle of convenience. The handle will not break or get stuck inside the knife handle. The knife can easily be removed and converted back to a knife on a person's belt. Since the knife is simply unscrewed for removal, the adaptor does not damage your knife handle. This adaptor is sized for threaded handled knives such as Sag Spirits, and Smith & Wesson Sw8.

Another popular type of knife, like the Cold Steel Bushman, used in the hunting and survival communities, has a wedge shaped socket handle with a hole near the bottom for attachment. This adaptor is wedge form, conically tapered for insertion into this type of knife handle. A hole in the adaptor aligns with the hole in the handle to put in a removable quick release ring pin for securing. The adaptor's opposite end is male threaded complementing the interior threads of the tube used with the first mentioned adaptor.

Prior art uses a nail, screw, tack, or other such device for attachment. This type of system requires a hammer, screwdriver, or other tool to attach the knife. This system inevitably leads to a wobbling knife as well as difficulty removing the knife without damaging it. The capability of removing and reattaching knife handles while maintaining a snug connection is insured with this adaptor. By using the quick release pin, the knife is easily removed each time. The adaptor is made of rigid material, preferred embodiment is a substantial gage aluminum, eliminating the wear causing ill fit due to use and time. There is no special knowledge for utilizing this adaptor. One simply has to screw it onto the support tube, then insert the tapered end into the knife handle, line up the holes in each piece, and place the pin inside the holes to secure the handle. The pin is accessible on a connecting chain or cable-like line, secured to the resting edge of the adaptor, so it will not be lost or dropped in the process.

These adaptors meet the need for a substantial mounting platform for knives. They are each made into a single apparatus for simplistic attaching and an efficient utilization of time. They are removable. There is no special knowledge required in order to use these adaptors. They are durable, sturdy, steady, lightweight, and convenient. They are interchangeable with individually sold knives. They will save the consumer time and money.

### SUMMARY

In accordance with two embodiments, adaptors, one threaded on each end and one conically tapered end with threaded opposite end, and a complementary threaded rigid support tube.

### DRAWINGS

FIG. 1 shows the adaptor with two threaded ends.

FIG. 2 shows the two threaded end adaptor attaching to the support tube and knife handle.

FIG. 3 shows the conically tapered adaptor.

FIG. 4 shows the conically tapered adaptor attaching to the support tube and knife handle along with pin placement.

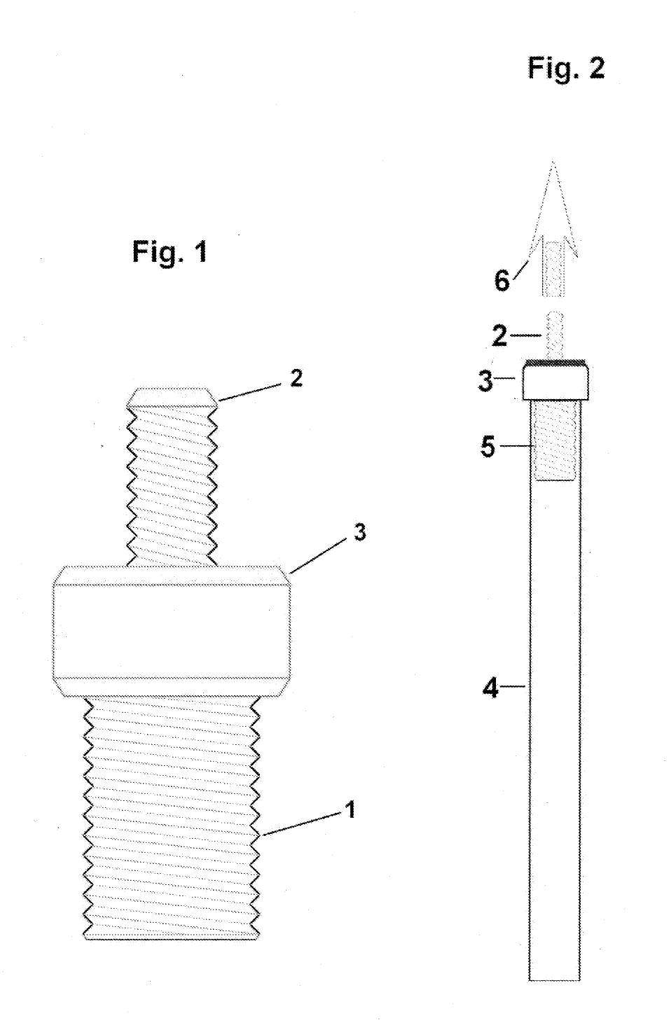

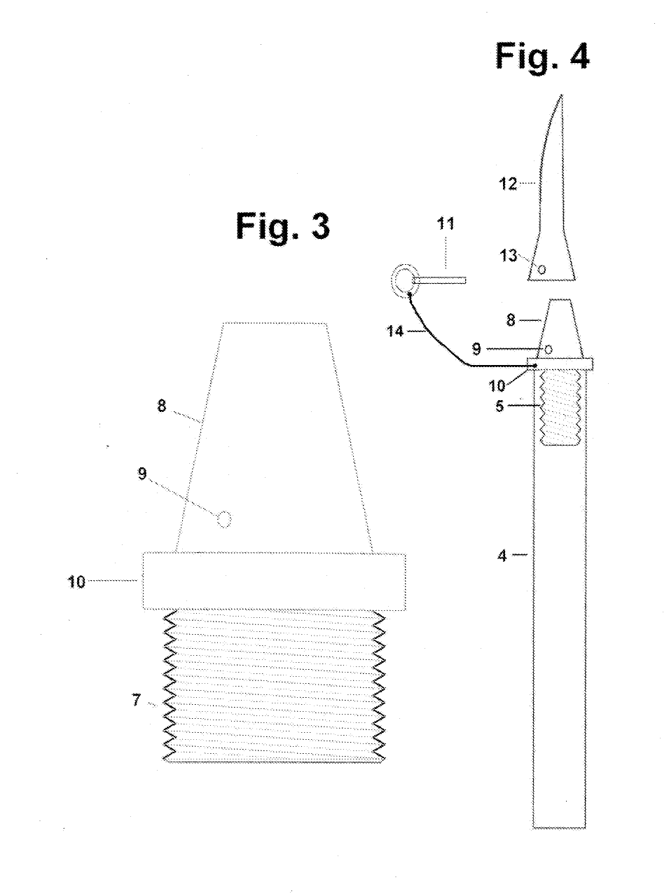

### DRAWINGS—REFERENCE NUMERALS

1 threaded end complementary to tube
2 threaded end complementary to knife handle
3 separation edge between threaded ends
4 rigid support tube
5 interior threads
6 threaded handle knife
7 threaded end complementary to tube
8 conically tapered end
9 cylindrical slot
10 resting edge for knife handle
11 pin with ring
12 holed handle knife
13 knife handle hole
14 cable-like connector to pin

I claim:

1. An adaptor comprising: a threaded component and a complementary threaded rigid elongated tube, whereby, in use, attached to a knife handle provides a secure, durable, and removable mounting apparatus as a mean of extending the proximity of range to a plurality of knife handles.

2. Said adaptor of claim 1 preferred embodiment is steel, however, stainless steel, carbon fiber, pvc, metal, metal alloy, and combinations thereof, are acknowledged.

3. Said adaptor of claim 2 being a preferred embodiment steel bar male threaded at opposing ends.

4. Said threads of claim 3 are cylindrical with one end being greater in diameter than the opposing end and the ends separated by an edge of greatest diameter.

5. Said edge of claim 4 is a size suitable for grasping with a hand.

6. Said greater diameter end of claim 3 is complementary to threads of said tube.

7. Said lesser diameter end of claim 3 is complementary to define said plurality of knife handles.

8. Said tube of claim 1 being a predetermined length.

9. Said tube of claim 8 preferred embodiment is aluminum, however, stainless steel, carbon fiber, pvc, and other materials are acknowledged, is interior threaded.

10. Said tube of claim 9 is interior threaded approximately 2 inches in depth.

11. Said threads of claim 10 are complementary to greater diameter end of said adaptor in claim 2, whereby screwing together said adaptor and said tube provide a durable, secure, mounting platform for said plurality of knife handles.

12. Said platform of claim 11 screwing together with knife handle whereby extending the proximity of range when utilizing said knife.

13. An adaptor comprising: a threaded lower end and an upper conically tapered end separated by a greater diameter edge providing a stopping place for said knife handle to rest whereby, in use, attached to a knife handle comprising a hole for connection, provides a secure, durable, and removable mounting platform as a means of extending the proximity of range to a knife handle.

14. Said adaptor of claim 13 preferred embodiment is aluminum, however, stainless steel, steel, carbon fiber, metal, metal alloys, and combinations thereof, are acknowledged.

15. Said lower end of claim 13 male threaded complementary to the interior threads of said tube whereby screwing together provides a secure connection.

16. Said edge of claim 13 is located between lower threaded end and upper conically tapered end whereby providing a stopping edge when attaching knife handle.

17. Said conically tapered end of claim 13 comprises a smoother surface tapered conically with smaller end of cone at the top.

18. Said conically tapered end of claim 13 comprises a horizontal cylindrical slot near bottom of cone shape, near top of said edge in a predetermined place.

19. Said slot of claim 15 to align with said hole in knife handle.

20. A rigid pin, preferred embodiment quick release zinc coated, with means to remove, inserted into said aligned holes of claim 18 whereby securing said knife handle of claim 13 onto said adaptor of claim 13 providing an extended proximity of range when utilizing said knife.

21. Said rigid pin of claim 19 is attached to said edge of claim 13 whereby providing security and accessibility of said rigid pin.
